(19) United States
(12) Patent Application Publication
(10) Pub. No.: US 2013/0155641 A1
(43) Pub. Date: Jun. 20, 2013

(54) RELAY MODULE

(71) Applicant: ROBERT PROFETA, Carmel, CA (US)

(72) Inventor: ROBERT PROFETA, Carmel, CA (US)

(21) Appl. No.: 13/326,259

(22) Filed: Dec. 14, 2011

(51) Int. Cl. H01H 45/02

(52) U.S. Cl. 361/820

(57) ABSTRACT

Disclosed herein is an improved relay for replacing an electro-mechanical relay and converting the original electro-mechanical relay to a solid state relay. The improved relay includes a housing module having an interior. The interior includes a plurality of existing relay tabs and wires. The wires electrically connect the tabs to a connection member. The invention also includes a solid state relay member having a solid state relay module. The module includes a plurality of solid state relay contacts, each corresponding to the existing tabs. The plurality of solid state relay contacts are mounted on, for example, a PC board and adapted for connection to the housing module connection member. Additionally, the existing relay includes a power tab and the wires and connection member are adapted to provide power to the solid relay module for powering each of the solid state relay contacts.

### BACKGROUND OF THE INVENTION

### Field of the Invention

This invention relates to analog electro-mechanical relays used in the nuclear energy industry and more particularly this invention relates to replacing such analog electro-mechanical relays with a printed circuit board and integrated chips

In the world of nuclear power plants, there exists an electro-mechanical relay, namely, a GE CR120K relay, which is essential to reactor control and rod positioning. Unfortunately, this relay is no longer made by its original manufacturer, General Electric. Currently, there exists no logical or functional alternative. Power station operators are faced with the grim prospect of redesigning their entire relay system at a substantial cost.

To redesign and replace the current system of relays would take a considerable effort. Additionally, the price of such redevelopment would be substantial and divert funds and resources from the operator's principle basic mandate of providing safe and reliable energy to the public. As is well known, nuclear power plants face tremendous public scrutiny and can ill afford to divert any of their resources from their basic mandate. Thus, the problem of maintaining a safe operating power is complicated by GE's decision to no longer manufacture the CR120K relay.

Replacing the entire relay system could potentially lead to plant shut downs and to a lack of a reliable energy supply for the public. And, again, additional man-hours would need to be devoted to redesigning the existing electro-mechanical relay, instead of providing safe and reliable energy to the operator's customers.

In an effort to solve the operator's problems and to allow the operator to use its resources to develop and maintain a safe a reliable source of power, Applicant has developed a structure, which changes the basic nature of the relay without changes to the basic characteristics of the same. The critical physical and electrical specifications of the relay remain the same so that existing relay structures and the general system of relays need not be changed. However, the basic electro-mechanical relay is replaced by Applicant's structure to provide a more reliable and easily replaceable structure without changing the basis relay system.

### SUMMARY OF THE INVENTION

It is an object of this invention to provide an improved relay.

It is an additional object of this invention to provide such an improved relay, which converts a standard electromechanical relay into a solid state relay.

It is an additional object of this invention to provide a improved relay for CR120K relay, which converts the CR120K relay from an electro-mechanical relay into a solid state relay without causing the existing user to redesign either the existing relay or the existing circuit.

In accordance with the above objects and those that will be mentioned and will become apparent below, the replace relay module in accordance with this invention comprises:
An improved relay for replacing an electro-mechanical relay and converting the original electro-mechanical relay to a solid state relay, the improved relay comprising:
   a housing module having an interior including;
      a plurality of electro-mechanical contacts;
      a connection member; and
      means for electrically connecting the electro-mechanical contacts to the connection member mechanical relays the connection member;
   a solid state relay member including;
      contact means for electrically connecting the plurality of electro-mechanical contacts to the solid state relay member; the solid state relay member adapted for connection to the housing module connection member; and
   power tab means for accepting electrical for powering each of the contacts.

In a preferred embodiment of the solid state relays are attached to a pc board. The connection member sits outside the interior of the housing. And, the pc board plugs into the connection member.

In another preferred embodiment of the improved relay module, in accordance with this invention, the connection member sits inside of the interior of the housing and the pc board connects to the connection member in the interior of the housing.

In either or both of the above embodiments, the critical physical dimensions of the improved relay module are the same as the original electromechanical relay. In the existing relay, there will likely be a series of mechanical tabs, both on the housing and in the rack mount. The mechanical tabs used to connect the relays to the Information System, in general, are used by the improved relay.

In another preferred embodiment of the improved relay module, in accordance with this invention, the relay includes an electrical circuit for communicating open and closed states. Within the relay circuit are the abilities to account for voltage drop-outs and built in time delays.

It is an advantage of this invention to a provide a new and improved solid state relay, which replaces the original electro-mechanical relay.

It is an advantage of this invention to a provide a new and improved solid state relay, as set forth above, which allows improved of the original electro-mechanical relay without having to redesign either the relay circuit or the physical or electrical structure of the existing relay system.

It is an additional advantage of this invention to a provide a improved relay module which can replace the original electro-mechanical relay, while the power facility continues is operation and without losing functionality or loss of power generation.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is an overview of the improved relay system in accordance with this invention shown in an exploded view.

FIG. 2 is an overview of the improved relay system in accordance with this invention shown in an assembled view.

FIG. 3 is a partial cross section of the improved relay module in accordance with this invention.

FIG. 4 is a front view of the improved relay module in accordance with this invention.

FIG. 5 is a top view of the improved relay module in accordance with this invention with the cover of the housing of the module removed.

FIG. 6 is a bottom view of the improved relay module in accordance with this invention.

FIG. 7 is a top view of the improved relay module in accordance with this invention with the cover of the housing of the module removed and the solid state relay contacts connected to the housing.

FIG. 8 is a side view of FIG. 7 the improved relay module in accordance with this invention further illustrating the solid state relay contacts connected to the housing of the module.

### DETAILED DESCRIPTION OF THE INVENTION

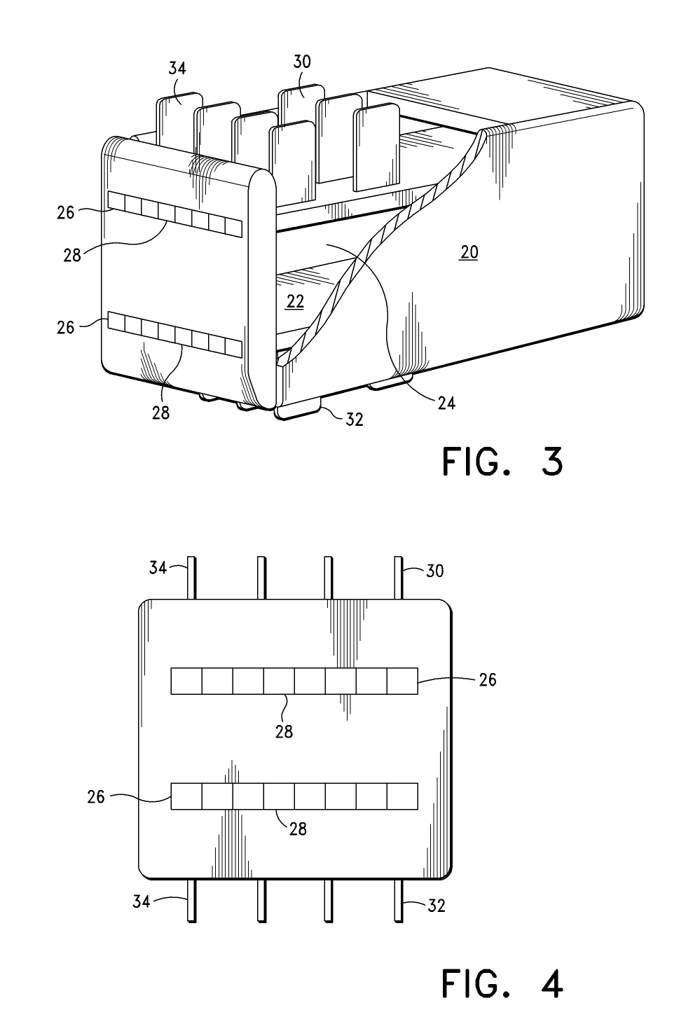

The invention will now be described with respect to FIGS. 1-8, which illustrates a preferred embodiment of the improved relay module in accordance with this invention shown generally by the numeral 10.

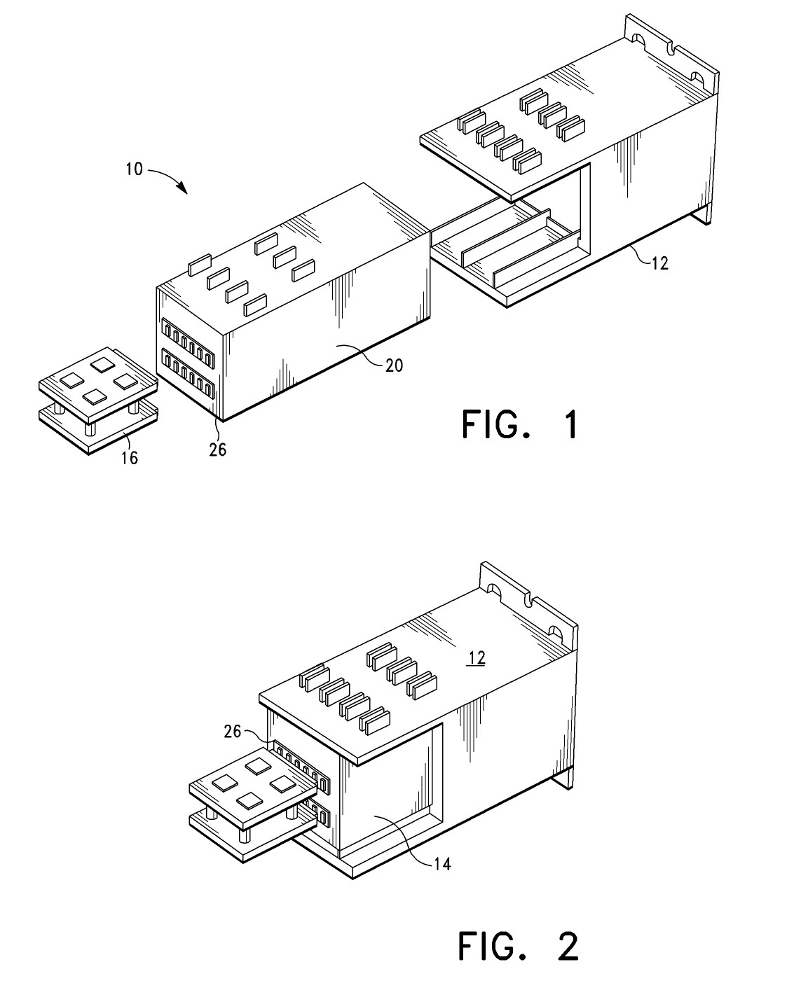

As shown particularly with respect to FIGS. 1 and 2, there are three basic elements of the solid state working relay system, in practice. First, there is the existing panel mounted receptacle 12 for rack mounting for the electro-mechanical relay modules. Second, there is the converted relay module 14, which includes the electro-mechanical relay module adapted for connection to solid state relay module. And, third, the solid state relay module 16, which includes the solid state relay contacts and means for electrically connecting the solid state relay contacts with relay module 14.

These three elements are shown in exploded view in FIG. 1. Thus illustrated, one can easily be see how the three elements fit together in FIG. 2. As will be appreciated by those skilled in the art, when assembled, as shown in FIG. 2, the existing electro-mechanical relay becomes a solid state relay without changing the basic design of the existing electro-mechanical relay. The details of the converted relay module 14 and the solid state relay module 16, follow below with reference to FIGS. 3-8.

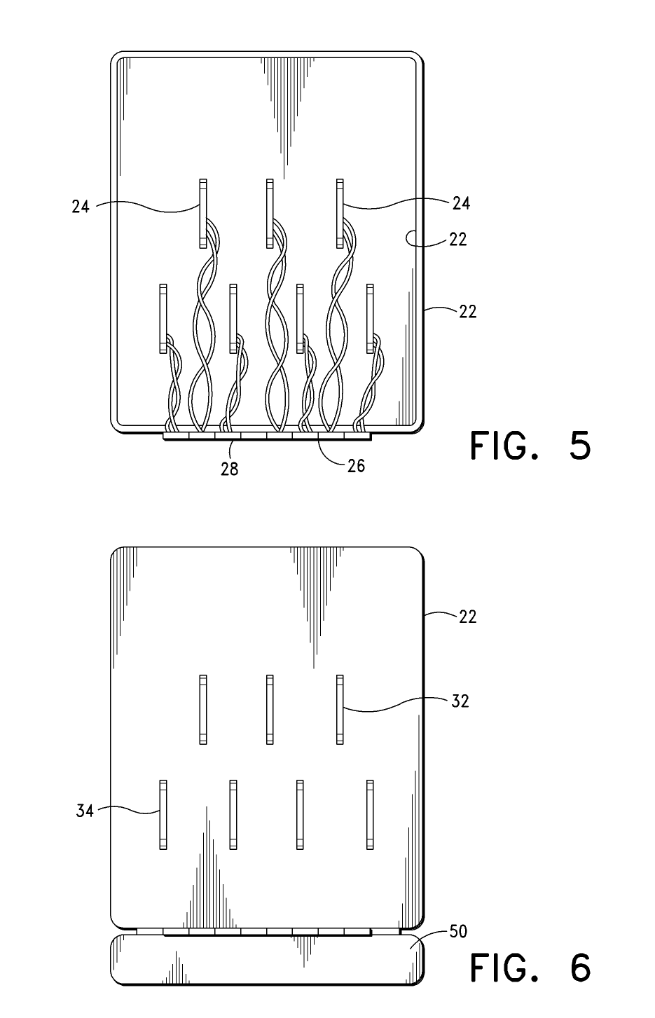

As seen in FIGS. 3-8, the converted or improved relay module 16 in accordance with this invention includes a housing 20 having an interior 22, as best seen in FIGS. 3, 5, and 7. The housing 20 includes a plurality of electro-mechanical relay contacts 24 (FIGS. 5 & 7). A connection member 26 connects to each the electro-mechanical relay contacts 24. The connection member also provide a plug-in connector 28, so that other elements, namely the PC board my be plugged in and electrically connected to the electro-mechanical relay contacts 24.

Typically, the existing electro-mechanical module has a top and a bottom row of relay contacts. These relay contacts are often designated A for the top row and B for the bottom row. A connection member 26 is provided for each of the top rows and each of the bottom rows. Likewise, a plug in connector 28 is provided for of the top and bottom rows, A and B.

In order to make electrical contact between the relay contacts of the module and the panel in the existing relay system, a tab 30 is provided. The tab 30 corresponds to a particular relay. Furthermore a tab is typically located on the outside of the housing and on the same side. For example, an electro-mechanical relay on the top or the A side will be located outside of the housing on the top of the module. Each such electro-mechanical relay will have such a corresponding tab.

Similarly, each such electro-mechanical relay will have such a tab extending through the bottom of the housing for the B row. Thus, as illustrated in FIGS. 3 & 4, each electro-mechanical relay will have a corresponding tab 32 extending through the housing 20 on the bottom of the module 14. Again, these are the existing tabs of a typical relay relevant to this invention. And, again, the tabs 32 make corresponding electrical contact as in the exist electro-mechanical relay system.

Each of the rows, Row A and Row B, include a power tab 34 for providing power to the relay contacts and the circuit that control them.

As illustrated in FIGS. 5 & 7, each of the electro-mechanical relay contacts 24, is electrically connected to the connection member 26 and plug-in connector 28 through a wire member 40. The wire member 40 includes wire pair for connecting the electro-mechanical relay 24 to the connection member 26 and to the corresponding location in the plug-in connector 28. All of the electro-mechanical relay contacts 24 in row A are connected to the top portion of the plug-in member 28, while all of the electro-mechanical relay contacts 24 in row B are connected to the bottom portion of the plug-in member 28.

The wire member 40 is a conventional twisted wire pair and are adapted for a maximum of 5 amps.

With particular reference to FIGS. 6-8, there is shown the solid state relay module 16 connected to the relay module 14 through an adapter 50. The adapter 50 plugs directly into plug-in member 28. The adapter 50 is shaped and sized so that the corresponding sold state relay matches with the electro-mechanical relay 24. If necessary, the adapter 50 provides electrical and physical compensations between the solid state relay contacts and the electro-mechanical relay contacts.

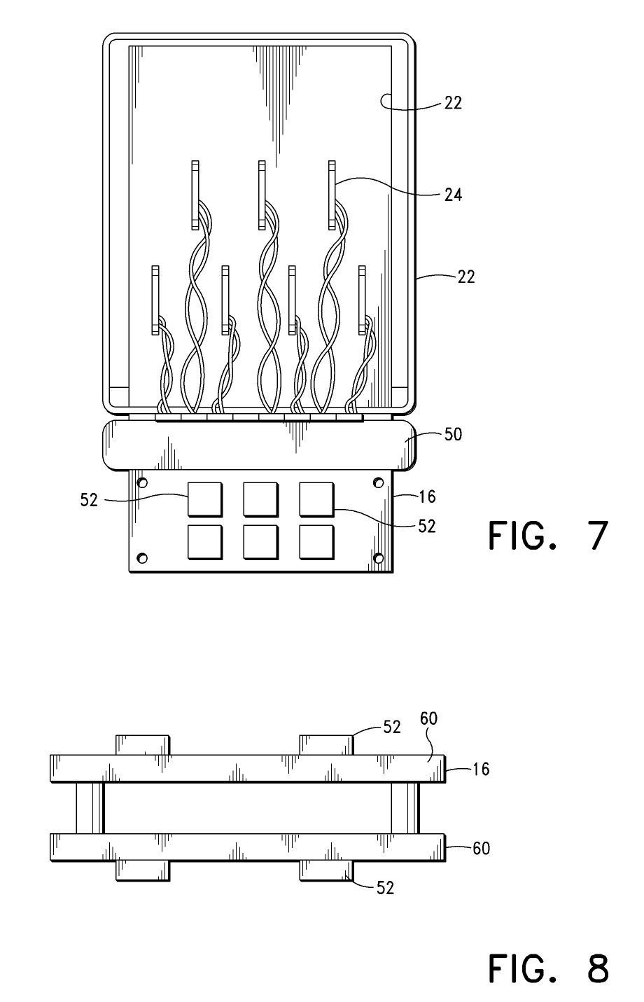

With particular reference to FIGS. 7 & 8, there is illustrated the solid state module 16 connected to the adapter 50 for electrically connecting the solid state relay contacts to the general system. The solid state module 16 includes a solid state relay 52 corresponding to each electro-mechanical relay 24. The power tab 34 supplies the electrical power needed to power the solid state module 16 from the control system.

The solid state relay module 16 also includes a PC board, such as that illustrated in FIG. 8. In the preferred embodiment illustrated in FIG. 8, there are actually two PC boards 60 for each of the rows A and row B. The solid state relay contacts 52 are set appropriately for electrical and physical needs on the PC boards 60 and then plugged in the plug-in member 28 as earlier described.

In another embodiment, the relay circuit of the electro-mechanical relay module includes a delay timing circuit for delaying the picking up of the change of state of the relay. In this case, when the relay for example goes from the open to the closed position, the signal sent to the system control will be delayed by a predetermined amount of time. The amount of time is adjustable and in a preferred embodiment the delay will be three seconds.

Similarly, there exist a current embodiment of the electro-mechanical relay module, which includes a delay timing circuit for delaying the dropping off of the change of state of the relay. In this case, when the relay for example goes from the closed to an open position, the signal sent is held by the system control for an extra period of time. The amount of time is adjustable and in a preferred embodiment the delay will be five seconds.

in order to accommodate this functionality of the existing electro-mechanical relay module, the invention, in an exemplary embodiment includes a circuit, which replicates each of the above functions. Specifically, the module in accordance with the invention includes a dedicated circuit on the pc board, which allows the user to adjust the time delay period for “pick up” and “drop off” states of the relay contacts. Additionally, the time period for each of the “drop off” and “pick up” states may be adjusted to zero or in effect, turned off.

In another preferred embodiment, the solid state module includes integrated circuits as the solid state relay contacts.

In yet another preferred embodiment, the solid state module connects to the electro-mechanical relay contacts within the interior of the housing 22. This means that the adapter 50 and connection member are all moved with the housing interior for connection therewith.

While the foregoing detailed description has described several embodiments of the golfing game in accordance with this invention, it is to be understood that the above description is illustrative only and not limiting of the disclosed invention. Particularly, the improved relay module may be located within or outside of the housing of the relay module. It will be appreciated that the embodiments discussed above and the virtually infinite embodiments that are not mentioned could easily be within the scope and spirit of this invention. Thus, the invention is to be limited only by the claims as set forth below.

What is claimed is:

1. An improved relay for replacing an electro-mechanical relay and converting the original electro-mechanical relay to a solid state relay, the improved relay comprising:
a housing module having an interior including;
a plurality of existing relay tabs;
a connection member; and
means for electrically connecting the tabs to the connection member;
a solid state relay module including;
corresponding solid state contacts for tabs for connecting the plurality of tabs to the solid state relay module;
the solid state relay module adapted for connection to the housing module connection member; and
power tab means for accepting electrical for powering the solid state relay module and each of the contacts.

2. The improved relay of claim 1, wherein the solid state contacts are mounted on a pc board and the pc board is adapted for connection to the housing module connection member.

3. The improved relay of claim 1, wherein the means for connecting the existing tabs to the connection member includes wire means tying the plurality of tabs together for electrical connection to the housing module connection member.

4. The improved relay of claim 1, wherein there is a first series of tabs on one side of the housing and a second series of tabs on the opposite side of the housing and wherein each of the tabs corresponds to a solid state relay contact and wherein there are an equal and corresponding number of solid state contacts and wherein the improved relay is adapted for mounting in a rack mount with the tabs corresponding to the location of the original electro-mechanical relay.

5. The improved relay of claim 1, wherein the relay is normally set in the open position.

6. The improved relay of claim 1, wherein the relay is normally set in the closed position.

7. The improved relay of claim 1, wherein the solid state relay module includes a timing circuit and wherein there is predetermined time delay pickup built into the timing circuit.

8. The improved relay of claim 1, wherein the solid state relay module includes a timing circuit and wherein there is predetermined time delay drop off built into the timing circuit.

9. The improved relay of claim 7, wherein the solid state relay module timing circuit is adjustable.

10. The improved relay of claim 8, wherein the solid state relay module timing circuit is adjustable.

11. The improved relay of claim 1, wherein the connection member is within the interior of the housing.

12. The improved relay of claim 11, wherein the solid state contacts are connected to the connection member within the interior of the housing.

13. The improved relay of claim 1, wherein the solid state contacts comprise integrated chips.

14. The improved relay of claim 12, wherein the solid state contacts comprise integrated chips.

15. The improved relay of claim 11, wherein the solid state relay module is within the housing interior.
